(19) United States
(12) Patent Application Publication
(10) Pub. No.: US 2015/0260859 A1
(43) Pub. Date: Sep. 17, 2015

(54) METHOD AND DEVICE FOR CORRECTING COMPUTED TOMOGRAPHIY MEASUREMENTS, COMPRISING A COORDINATE MEASURING MACHINE

(71) Applicant: WERTH MESSTECHNIK GmbH, Gießen (DE)

(72) Inventors: Ralf Christoph, Giessen (DE); Michael Hammer, Reiskirchen (DE); Ingomar Schmidt, Buseck (DE)

(21) Appl. No.: 14/427,112

(22) PCT Filed: Sep. 9, 2013
(86) PCT No.: PCT/EP2013/068585

§ 371 Date: Mar. 10, 2015

(30) Foreign Application Priority Data
Sep. 10, 2012 (DE) 10 2012 108 416.5

(51) Int. Cl. G01T 7/00; G01N 23/04

(52) U.S. Cl. CPC G01T 7/005; G01N 23/046

(57) ABSTRACT

The invention relates to a device and a method for correcting the results of a computed tomography measurement of the geometry of a workpiece, the computed tomography sensor system, which consists at least of a radiation source, a two-dimensional detector and a mechanical axis of rotation for rotating the workpiece or component, being integrated into a coordinate measuring machine. To provide a simple and inexpensive method for carrying out a distortion correction, imaging errors present on the detector are corrected by measuring a calibration object in at least two relative positions between the calibration object and the detector.

The invention relates to a method and device for correcting radiographic images, measured by means of computed tomography, of geometric features of an object such as a workpiece or component, in particular for the correction of imaging errors due to distortion and detector tilting.

The conducting of a distortion correction for flat image detectors with scintillator bodies is described for the first time in DE 10 2010 050 949 A1, to which reference is expressly made, and the description of which with regard to the basic function of distortion correction is to be regarded as part of the invention, and also since corresponding functions in image processing have long been part of the prior art. For the determination of the distortion error, the use of a calibrated object is exclusively proposed in DE 10 2010 050 949 A1. This must, moreover, cover the entire range of the detector which it is intended should be distortion-corrected.

A number of disadvantages are thereby faced. First, a relatively large calibration object must be provided. The features of this calibration object, in particular the dimensions of each individual feature and the distance interval of the features between one another, must all be calibrated, thereby incurring high costs for procurement and calibration. As well as this, it must be ensured that the calibration object is stable over the long term, which in turn incurs high manufacturing and recalibration costs. There is a further disadvantageous effect in that, due to the large surface area of the calibration object, imaging errors are incurred by the computer tomographic imaging, such as radiation scattering or narrow-angle radiation artefacts. Further errors occur due to the fact that the large-surface calibration object can only be aligned imprecisely at right angles to the mid-point beam of the radiation source, or, respectively, parallel to the detector surface. A further disadvantage is that multiple structures must be applied onto the calibration object and calibrated. It is also disadvantageous that the number of the structures on a corresponding calibration object is limited, and thereby also the lateral resolution of the distortion correction. Indeed in Section [0014] of DE 10 2010 050 949 A1 it is described that the course of the distortion over the surface is not subject to abrupt changes. This is not compatible, however, with random material deviations in the scintillator structure. These may also vary from detector pixel to detector pixel.

Another disadvantage with the known method is the fact that the identification of complicated structures such as crosses is necessary.

The object of the present invention is therefore to avoid the disadvantages of the prior art, and, in particular, to provide a simplified and economical method, as well as a corresponding arrangement for carrying out a distortion correction.

This object is essentially solved in that at least one preferably uncalibrated calibration object or one or more regions, sections, or parts thereof are used, which is/are arranged in different relative positions to the detector, and radiographic images are recorded, wherein correction values are determined from a reference displacement, derived from among the relative positions, and the actual displacement present in the radiographic images.

An uncalibrated calibration object is characterized in that the dimensions of the one or more regions, sections, or parts, such as the diameter of one or more spheres, and the distance intervals between a plurality of regions, sections, or parts used for the determination of the correction values, such as the distances between spheres, are unknown, or only known within the framework of the tolerances indicated by the manufacturers. As a result no measurement is made, for example with a coordinate measuring machine, in order to determine the dimensions and distance intervals precisely.

In order to carry out the positioning of the uncalibrated calibration object which is necessary for this, the computed tomography sensor system is integrated in a coordinate measuring machine, and the axes of the coordinate measuring machine are used for the relative movement between the calibration object and the detector, wherein, therefore, a displacement takes place along these coordinate measuring machine axes. In this way the coordinate measuring machine axes exhibit the necessary precision to determine these position changes or displacements.

As a calibration object which is particularly easy to prepare and economical to provide, the use of one or more spheres, such as steel spheres, has been proposed. These are required in any event for the determination of the geometry of the computed tomography sensor system, in particular of the image scale, and the corresponding securing devices are known from the prior art. In particular, the calibration object can also be used to calibrate the geometry of the computed tomography sensory system, or also as what is referred to as a drift sphere for determining the displacement of the focal point of the radiation source in relation to the remainder of the computed tomography sensor system or in relation to the object which is to be measured, as a result of which a further cost reduction is achieved.

Given that, according to the prior art, the recognition of complex structures such as crosses is necessary, it is sufficient according to the teaching of the invention, for example, for only the centres of gravity to be determined of simple objects such as spheres.

By the use of a calibration object which is moved in different relative positions to the detector, the distortion can advantageously be determined with an almost random number of intermediate points, i.e. with any desired degree of lateral resolution.

It is to be pointed out that the term “calibration object” also includes one or more regions, one or more sections, or one or more parts of such an object in order to determine correction values, without this having to be expressly mentioned.

In order to accelerate the method, use is preferably made of a calibration object consisting of a plurality of spheres. In this situation, several relative positions are again adopted, but it is now possible, with a reduced number of relative positions, to detect a higher number of intermediate points for the determination of the distortion. Advantageously, the distance intervals of the plurality of spheres do not have to be calibrated.

In a further inventive conception, the determination of the image scale of the computed tomography sensor system and the image errors, such as distortion errors, is carried out iteratively in a common method step. As a result it is noted that the image scale of the computed tomography sensor system determined initially are affected by the image errors. Subsequently, the distortions are determined and corrected on the basis of this measurement, and the image scale determined anew. A repeat measurement is not absolutely necessary for this.

In a separate inventive conception, the calibration object, such as a sphere, is arranged off-centre to the axis of the mechanical axis of rotation, and radiographic images are taken in different rotational positions of the mechanical axis of rotation. Taking account of the known distance interval between the axis of the mechanical axis of rotation and of the calibration object, and of the image scales present in the different rotational positions, a plurality of relative positions are thereby obtained in relation to the detector, such that, during a rotation with a sphere, the distortion is determined at least for a part of the detector. If a plurality of calibration objects, such as spheres, are arranged above one another, i.e. in the direction of the axis of the mechanical axis of rotation, it is possible, by one single rotation, for the distortion for the complete detector to be determined.

Ideally, the detector is aligned at right angles to the middle beam direction of the radiation source, and arranged in such a way that the direction of the mechanical axis of rotation runs in a plane parallel to the plane of the detector. In addition, the pixels of each line of the detector should run in the direction of or perpendicular to the direction of, the axis of rotation. With the corresponding adjustment of the detector, however, deviations always occur, at least in the three rotary degrees of freedom, referred to as detector tilts. As a result, distortions occur in the radiographic images taken, or, respectively, a locally different image scale.

The object of the invention is therefore also to correct image errors caused due to the tilting of the detector.

It has been shown that image errors caused due to detector tilting can be automatically determined with the method of the present invention. If, for example, the calibration object is moved in the detector plane, then, from the awareness of the movement really carried out, determined for example by the measurement axes of the coordinate measuring machine, and the movement determined with the detector, it can be identified, for example, in which direction the detector lines are running, and for a rotation or tilting about the normals of the detector surface to be corrected. From the additional comparison of the amounts of the movement carried out and the movement measured, a tilting about the other two axes can also be identified and corrected. Due to this tilting, for example, higher magnifications occur in areas of the detector which are a greater distance from the radiation source. This is shown by the fact that a greater displacement is detected by the detector than in fact occurred. By way of the correction of the radiographic image, however, this is, so to speak, “pushed together” in the corresponding regions, thereby providing a uniform magnification for the entire radiographic image.

Under certain circumstances extended surface detectors are formed from a plurality of part-detectors, in order to magnify the radiographic image detected, or to increase the resolution. These are arranged in the detector plane directly next to one another. Also possible in this situation is an arrangement of a plurality of detectors in both directions inside the detector plane next to one another, for example in rectangular shape of 2×2 detectors. Between every two detectors in each case is an interface. The images referred to as part radiographic images which are recorded by the part detectors are used to produce a composite image, which is later used for the reconstruction of the volume data. Due to the interfaces between the part detectors it is in general not possible to carry out a correction of imaging errors, in particular the interpolation of correction values, for adjacent regions or pixels, for the composed radiographic image.

A further object of the invention is therefore to provide the correction according to the invention also for detectors composed of part detectors or radiographic images composed of part images.

To solve this object, the invention makes provision for the correction according to the invention to be used, in particular to be carried out separately for each part radiographic image. In particular, the interpolation of correction values takes place in each case only for the detector pixels inside a part radiographic image, i.e. not across the interfaces.

In particular, the invention relates to a method for the correction of radiographic images of a computed tomography measurement of geometric features or geometries of an object such as a workpiece or component, wherein the computed tomography sensor system, consisting at least of radiation source and extended surface detector and, as appropriate, a mechanical axis of rotation for the rotation of the object, is integrated into a coordinate measuring machine, wherein the method is characterized in that imaging errors present on the detector are corrected by measurement of a calibration object in at least two relative positions between calibration object and detector, wherein correction values are determined from a comparison between a reference displacement deriving from the relative positions and an actual displacement present in the radiographic images.

As a result, in a preferred further embodiment, the invention provides for the measurement to comprise the recording of a plurality of radiographic images, wherein the preferably uncalibrated calibration object, or different parts of the calibration object, such as, for example, a plurality of spheres, are imaged in each case on different regions of the detector, and the position changes (the reference displacement) carried out between the recordings of the radiographic images are determined from the movements of the coordinate measuring machine axes and/or by means of a further sensor.

It is to be emphasised and specific to the invention that the correction of the imaging errors caused by distortion and/or by detector tilting is carried out in that
the actual displacement of the calibration object or of the regions, sections, or parts thereof is determined on the detector by the evaluation in each case of two radiographic images, preferably by the determination of the centre of gravity of the calibration object or of the regions, sections, or parts in the respective radiographic image,
the known position change of the calibration object or of the regions, sections, or parts, taking account of the image scale, defined by the relationship of the “detector-radiation source distance interval” to the “measured object or calibration object-radiation source distance interval” of the computed tomography sensor system, is converted into a reference displacement of the calibration object or of the regions, sections, or parts on the detector,
the deviations between reference and actual displacement are determined, and
the pixel regions of the detector comprising the calibration object or the regions, sections, or parts in the different positions are displaced relative to one another in accordance with the reference-actual value deviation, in order to form a corrected radiographic image.

In particular, the invention allows for the relative displacements to take place in relation to the middle range of the detector, i.e. at least one radiographic image is taken, with which the calibration object or a part of the calibration object is imaged approximately in the middle on the detector.

Another characteristic is the fact that, as the radiographic image, an image is used which is composed of part radiographic images, wherein the part radiographic images are taken by a plurality of extended surface part detectors, which are arranged in the detector plane directly next to one another, wherein preferably 2×2 part detectors are used, and preferably the correction for each part radiographic image takes place separately, in that, per part detector, radiographic images are taken for a calibration object or one or more regions, sections, or parts thereof in different relative positions to the part detector.

Preferably provision is made such that, by means of interpolation from correction values from adjacent regions or pixels of the detector, correction values are determined for all detector pixels.

In one embodiment, the invention makes provision for the interpolation of correction values to take place in each case only for the detector pixels inside a part radiographic image.

The invention is further characterized by the fact that the corrected radiographic images are provided by means of resampling in the original grid.

In this situation, provision is made in particular for the corrected radiographic images to be used for the reconstruction of the volume data.

According to the invention, at the recording of the correction values, first the imaging scale present must be known, at least roughly, i.e. approximately, in order to determine the displacement in the detector plane resulting from the reference displacement of the coordinate measuring machine axes. This therefore represents a rough calibration. The calibration of the magnification is repeated after the determination of the correction values which are necessary for the determination of corrected radiographic images, wherein this repeat and more precise calibration already takes place with the use of the correction according to the invention. This procedure can also be repeated several times, iteratively; i.e. after the more precise calibration, a further determination of still more precise correction values takes place.

A further feature to be emphasised is the characterisation that the correction of the imaging errors is applied with a repeated and more precise calibration of the imaging scale or the magnification, i.e. of the determination of the geometry of the computed tomography sensor system, and, during the measurement, the geometry of a workpiece or of a component is used.

In particular, provision is made for the measurement of the different radiographic images of the calibration object for the determination of imaging errors and the determination of the imaging scale or the magnification by the computed tomography sensor system to be carried out in one common method step and with the same calibration object, wherein preferably first the magnification is determined and then the imaging errors, and these two steps are repeated once or several times, iteratively.

Preferably, the invention makes provision for the calibration object to consist of an arrangement of a plurality of preferably spherical elements, that are arranged in such a way that the plurality of elements extend parallel to the axis of the mechanical axis of rotation, preferably along the axis of the mechanical axis of rotation and the different relative positions are recorded at the same distance from the detector.

The invention is further characterized by the fact that the calibration object is arranged off-centre to the axis of the mechanical axis of rotation, wherein preferably the distance from the axis or location of the axis is known, the calibration object preferably consists of a plurality of spheres offset in the direction of the axis of the mechanical axis of rotation, and the different relative positions are adopted by the different rotational positions of the mechanical axis of rotation, and the imaging errors are determined by taking account of the image scale present, dependant on the respective rotational position.

Another characterising feature is that the calibration object is connected to a clamping device of the object, such as a workpiece or component, or to the mechanical axis of rotation.

In one embodiment the invention makes provision for a sphere or a plurality of spheres to be used as the calibration object.

A coordinate measuring machine, in particular for carrying out individual method measures of those described hereinbefore, which comprises a computed tomography sensor system with at least one radiation source, an extended surface detector, and, as appropriate, a mechanical axis of rotation with a passage axis, is characterized in that the calibration object is connected to a clamping device for the object connected to the mechanical axis of rotation or to the mechanical axis of rotation, directly or indirectly, preferably by way of a holder, wherein the connection or the securing element or the holder consist of a material which, in comparison with the calibration object, has a lower absorption with respect to the measurement radiation emitted from the radiation source, and preferably the absorption is at least five times lower.

Preferably provision is made for the calibration object to comprise one or more elements, in particular a sphere or an arrangement of several spheres, which in each case are spaced at a distance from one another or from the basic body by means of at least one securing element, and that the calibration object can preferably also be used as a drift body and/or for the determination of the image scale of the computed tomography sensor system.

The invention is also characterized in that the plurality of elements of the calibration object extend along the axis of the mechanical axis of rotation or are arranged off-centre to the axis of the mechanical axis of rotation, wherein preferably the calibration off-centred object is arranged in such a way that, on the rotation of the mechanical axis, this can only be shadowed by the securing elements of lower absorption, i.e. it is located above a rotation plate of the mechanical axis of rotation.

A further aspect of the invention is characterized in that the one element or plurality of elements, such as spheres, are secured in a holder, preferably a cylindrical holder, which exhibits one or more openings running transverse to the cylinder axis, arranged such that in each case one or more elements, such as spheres, are arranged on connection elements secured in the cylinder, such as webs or pins, or in another material such as a foam type material, of which the absorption is less than that of the element(s).

In particular, provision is made for the plurality of spheres to be arranged offset to one another in the direction of the axis of the mechanical axis of rotation.

In one embodiment, the invention makes provision for the extended surface detector (2) to comprise a plurality of extended surface part detectors, which are arranged next to one another in the detector plane, and which can be used to create complied radiographic images, wherein preferably 2×2 part detectors are arranged.

Further details, advantages, and features of the invention can be derived not only from the claims, the features to be derived from them, individually and/or in combination, but also from the following description of the figures.

These show:

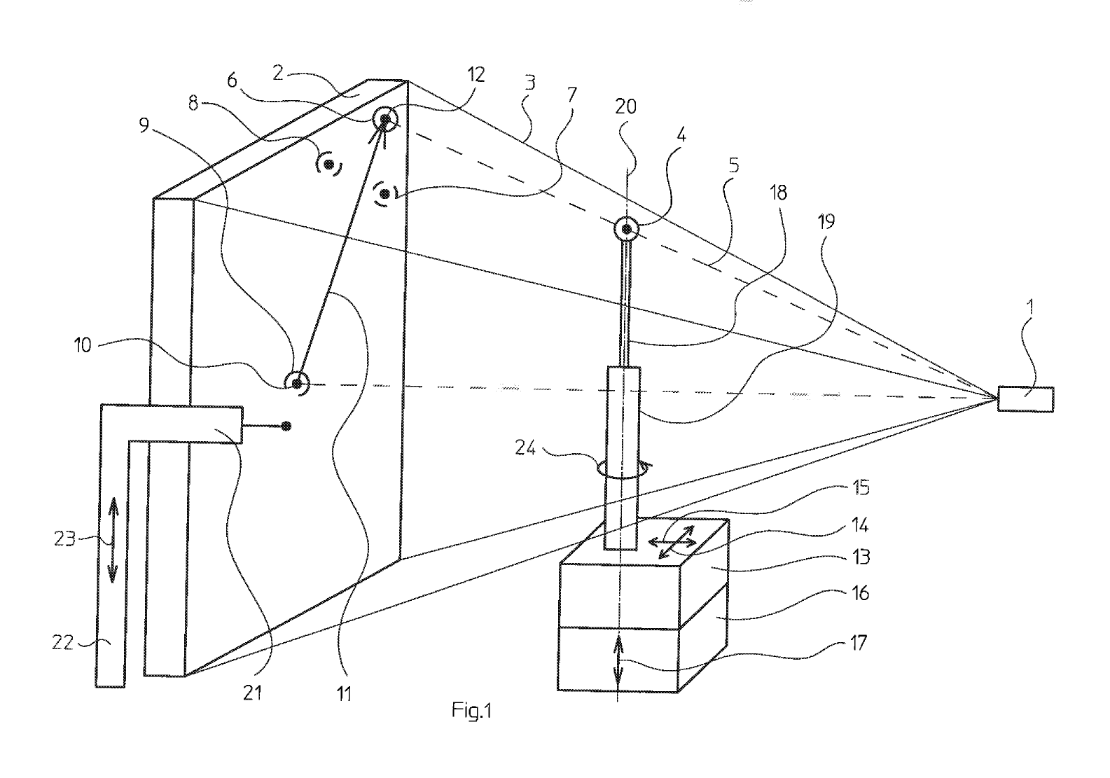

FIG. 1 The device according to the invention with one single calibration object,

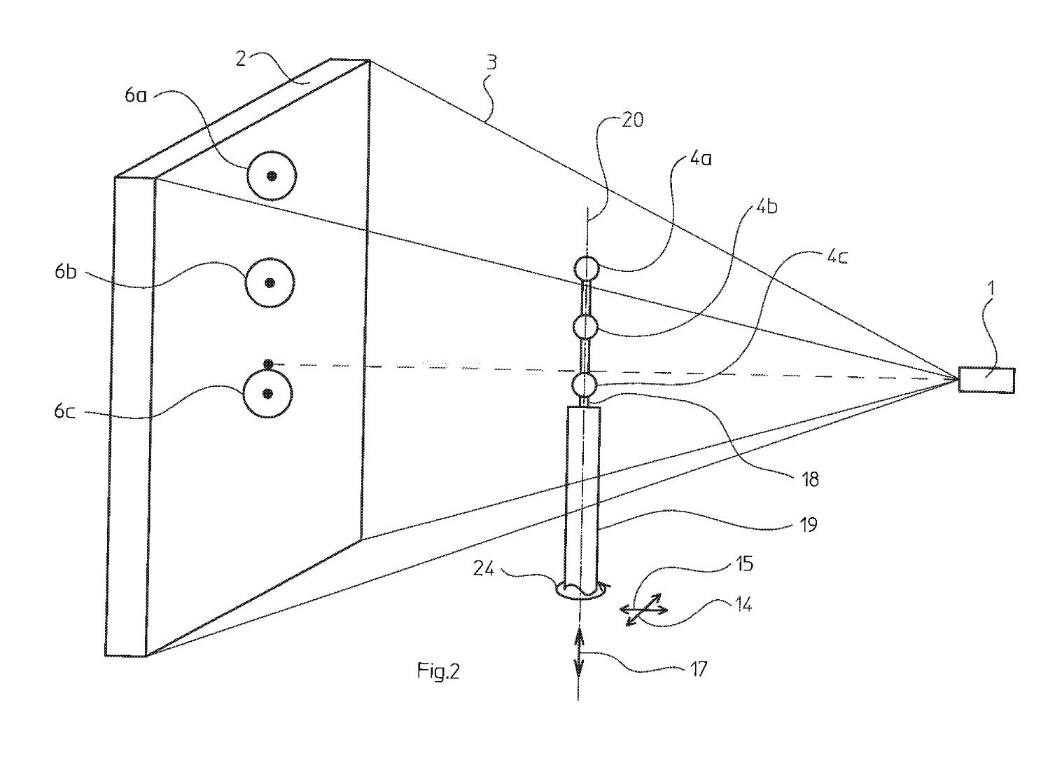

FIG. 2 An embodiment of the device according to the invention with a plurality of calibration objects,

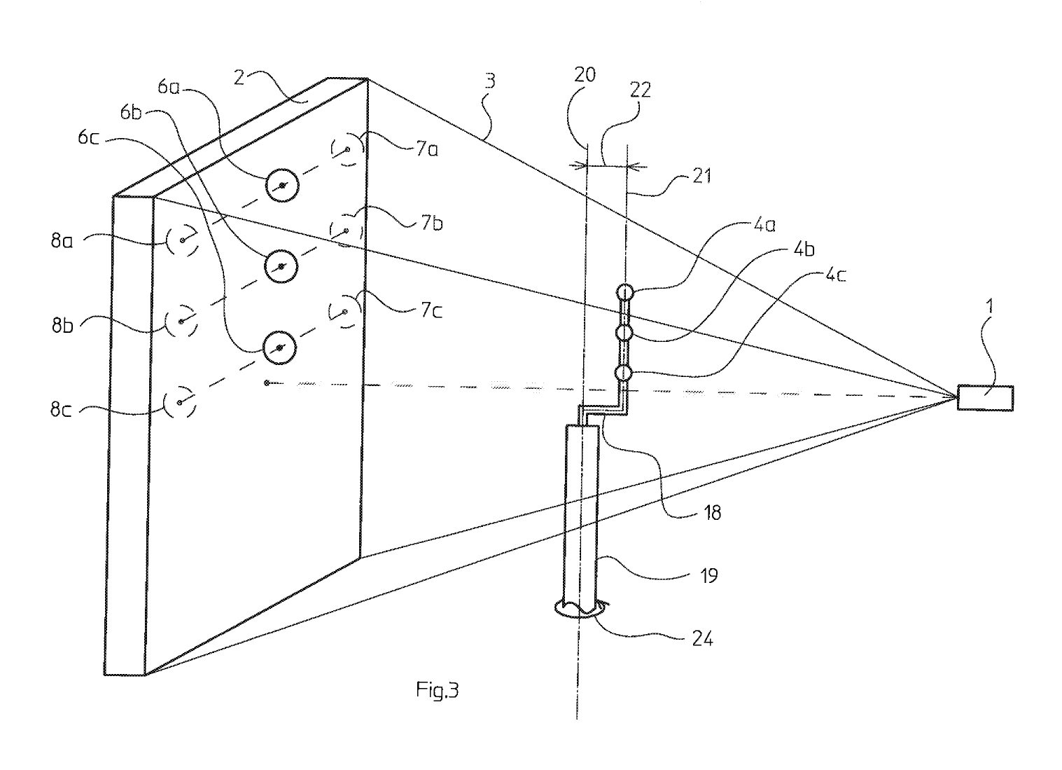

FIG. 3 A further inventive embodiment of the device according to the invention, with a changed arrangement of the calibration objects,

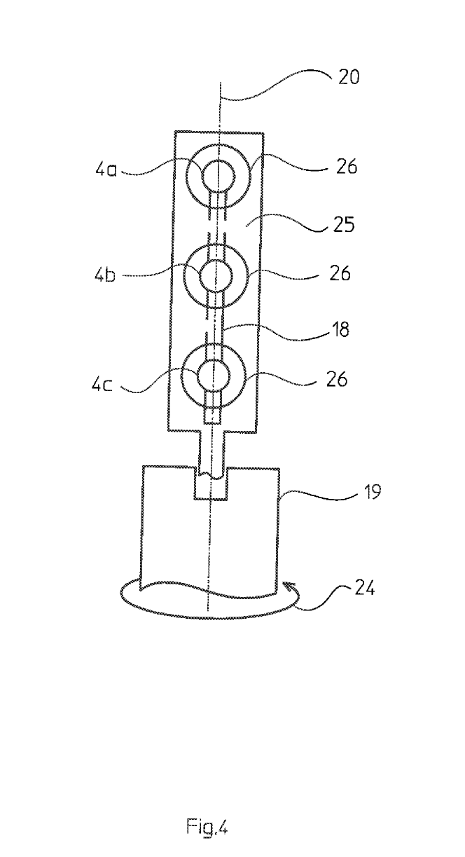

FIG. 4 A possible embodiment of a device with a plurality of calibration objects, and

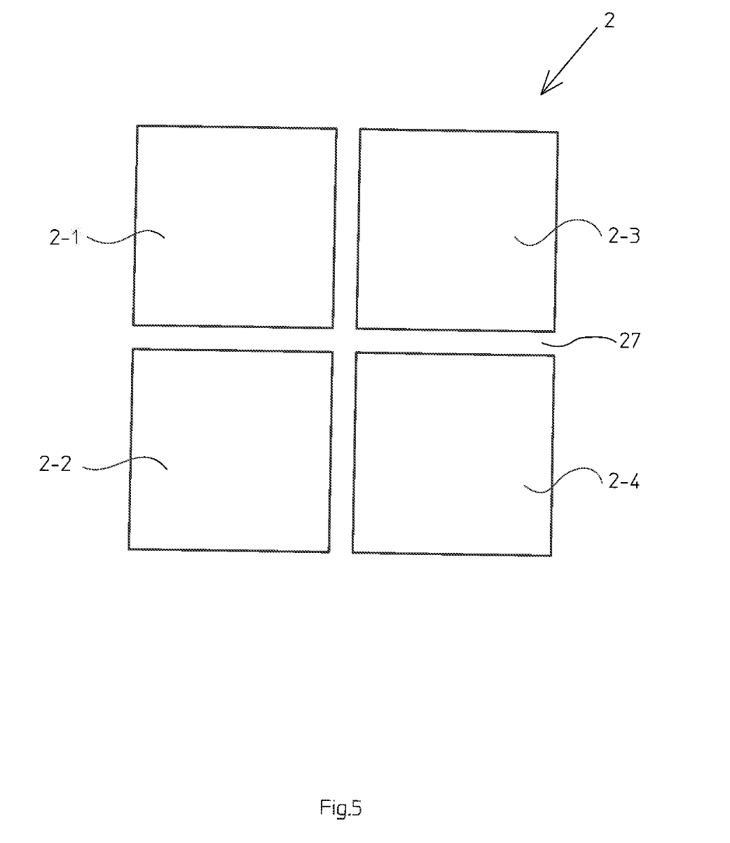

FIG. 5 A detector arrangement.

FIG. 1 shows a device according to the invention, comprising a radiation source, such as an X-ray source 1, a flat radiation detector 2, and a calibration body 4, which is positioned by means of a mechanical axis of rotation 19 and linear displacement units 13 and 17 into different relative positions in respect of the radiation source 1 and the detector 2. The radiation 3 emitted by the radiation source 1 is imaged on the detector 2. As a result, among other factors, the calibration body 4, here in the form of a sphere, such as a steel sphere, is penetrated by the beam splitting bundle 5, and, due to weakening of the radiation, is imaged onto the detector 2 as a shadow image 6 (or, respectively, a weakened radiographic image). As the resultant positions on the detector, for example, the centre of gravity 12 is determined for this shadow image. According to the invention, the calibration body 4 is brought into at least one further relative position in respect of the radiation source 1 and the detector 2 and measured. For this purpose, the calibration body 4 is connected, or detachably connected, for example by means of a pin 18, to the mechanical axis of rotation 19, i.e. for example by a holder or a rotating plate, which moves along the direction of the arrow 24 about the axis 20 of the axis of rotation 19. Secured on the rotating plate 19 is also the object which it is intended should be assessed by the geometric features by means of computed tomography (CT). The mechanical axis of rotation 19 is in turn secured to the linear displacement unit 13, which allows for a movement along the directions of the arrows 14 and 15, and to the linear displacement unit 16, which allows for a movement in the direction of the arrow 17. As an alternative or in addition, similar linear adjustment units 13 and 16 or parts thereof are coupled to the radiation source 1 and/or the detector 2, in order to carry out the relative movement in respect of the calibration object 4. In order to identify the relative positioning precisely, the linear adjustment units 13 and 16 are equipped with scales, which determine the precise travel path. In an alternative embodiment, an additional sensor 21 may also be provided, such as an optical or tactile or tactile-optical sensor, which is positioned, for example by means of a separate linear adjustment unit 22, along the direction of the arrow 23. With this additional sensor 21, for example, the positions and the relative displacement of the calibration body can be determined. After the relative positioning of the calibration body 4, for example, the shadow image 9, with the centre of gravity 10, is present on the detector 2, or, respectively, by analogy, the shadow images 7 and 8. By way of multiple positioning, the entire range of the detector is travelled over, corresponding to a predetermined grid pattern, and the radiographic images which are taken during this process, which contain the respective shadow images, are stored. For each centre of gravity 12, 10 etc., the positions of the linear adjustment units 13 and 16 and, as appropriate, 22, are also stored. From these positions, making use of the image scale, reference positions are determined for the centres of gravity 10, 12 etc. Distortions which are to be taken into account are as a result corrected, in accordance with the disclosure of DE 10 2010 050 949 A1. In a special embodiment, these positions are used in relation to a first fixed position, which is located, for example, in the middle 10 of the detectors. The actual positions are determined from the respective radiographic images taken in each case, and the shadow images which they contain, and compared with the reference positions. In relation to the reference position 10 in the middle of the detector, the interval vector 11 for the actual position and the reference position is determined, and, from the difference between these, a correction for the detector pixel corresponding to the point 12 is calculated and applied. A corresponding procedure is carried out with the further positions and shadow images 7, 8, etc. respectively. In order to calculate the reference positions, the image scale must have been first at least roughly determined. This is defined as the ratio between the distance interval of the detector 2 from the radiation source 1 and the distance interval of the calibration body 4 from the radiation source 1.

On the basis of FIG. 2, a further device according to the invention is represented. In order to shorten the measuring time, three bodies 4a, 4b and 4c, as calibration bodies, are connected by means of a pin 18 to the axis of rotation 19. In a first relative position of the calibration bodies 4a to 4c in respect of the radiation source 1 and of the detectors 2, the shadow images 6a, 6b and 6c are derived on the detector 2. Accordingly. for each measurement, by way of example, the distortion correction can be determined for three detector ranges. The correction of further ranges takes place after the change in the relative position of the calibration object 4 by analogy in accordance with FIG. 1, by movement of the linear adjustment units 13 and 16, not shown, along the arrows 14, 15 and 17. As a reference position, each of the calibration bodies 4a to 4c are imaged at least once in the middle of the detector 2.

FIG. 3 shows a further embodiment of the device according to the invention. The calibration bodies 4a to 4c are in this situation arranged off-centre to the axis 20 of the mechanical axis of rotation 19, connected by the pin 18. As a result they extend at a distance interval 22 along the axis 21 parallel to the axis 20 of the axis of rotation 19. In a first rotational position of the axis of rotation 19, as a result, the shadow images 6a to 6c occur on the detector 2. Further relative positions of the calibration bodies 4a and 4c are now adopted by the rotation of the axis of rotation 19 about the axis 20. As a result, the shadow images 7a to 7c or, respectively, 8a to 8c, appear depending on the rotational position of the axis of rotation 19. In this way, per revolution or, respectively, half revolution of the axis of rotation, all the pixels of a plurality of detector lines can be corrected for distortion. By the positioning of the calibration body 4, consisting of the bodies 4, 4b and 4c, along the linear axis 17, not shown, corresponding to FIG. 1, the remaining detector lines of the detector 2 can also be corrected for distortion. For the determination of the image scale present, as well as knowing the image scale at the position of the axis 20 of the axis of rotation 19, the distance interval 22 to the axis 20 and the location of the rotational position about the axis 20 are also necessary.

On the basis of FIG. 4, a special embodiment is shown of the calibration body, consisting of the three spheres 4a to 4c, which, connected by means of the webs 18, are located in a cylindrical base body 25. This is in turn connected to the axis of rotation 19, rotating along the direction 24. Located in the body 25, transverse to the axis 20, are circular openings 26. These allow for an almost undisturbed imaging of the calibration bodies 4a to 4c on the detector 2. As an alternative to the pin 18, for example, other materials, for example of foam type, easily irradiated, i.e. materials with lower absorption than the calibration bodies 4a to 4e, are located in the interior of the body 25, in order to fix the calibration bodies 4a to 4c. As a result, thermal storage stability need only be guaranteed for the period of the calibration procedure, but not over a longer period.

FIG. 5 shows a detector 2, composed of the 2×2 part detectors 2-1, 2-2, 2-3 and 2-4. The part detectors are arranged next to one another in a plane, the detector plane, formed by the drawing plane, wherein a small gap or interface respectively pertains, a few fractions of a millimetre wide. Each of the part detectors accommodates a part radiographic image, which are then assembled to form the assembled radiographic image. This assembled radiographic image is then used for the reconstruction of the volume data. The correction according to the invention takes place, however, before the assembling of the part radiographic images, and, specifically, separately for each one of the part radiographic images. In particular, therefore, no interpolation is carried out over the interfaces. Rather, the method according to the invention is carried out separately for each part detector, and the interpolation of correction values is in each case carried out only for the detector pixels inside a part radiographic image. Should the part detectors be tilted towards the drawing plane, but also, within the drawing plane, towards one another, then different corrections are derived for the individual part detectors with the application of the method according to the invention. By the application of these different corrections to the respective part radiographic images, corrected part radiographic images are derived which in each case are present in a common plane, the drawing plane, and in the same orientation, i.e. angular attitude or, respectively, rotational position within the drawing plane, and can and are assembled to form the assembled radiographic image.

1. Method for correcting radiographic images of a computed tomography measurement of geometric features or geometries of an object, such as a workpiece or component, wherein the computed tomography sensor system, comprising at least a radiation source and extended flat detector and, as appropriate, a mechanical axis of rotation for the rotation of the object, is integrated into a coordinate measuring machine, characterized in that imaging errors present on the detector are corrected by measuring of a calibration object in at least two relative positions between calibration object and detector, wherein correction values are determined from a reference displacement derived in the comparison between the relative positions and an actual displacement present in the radiographic images.

2. Method according to claim 1, characterized in that the measurement comprises taking a plurality of radiographic images, wherein the preferably uncalibrated calibration object or regions, sections, or parts of the calibration object, such as, for example, a plurality of spheres, are imaged in each case on different regions of the detector, and the position changes carried out between the takes of the radiographic images (reference displacement) are determined from the movements of the axes of the coordinate measurement machine and/or by means of a further sensor.

3. Method according to claim 1, characterized in that the correction of the imaging errors, caused in particular by distortion and/or detector tilting, in carried out in that
the actual displacement of the calibration object or the regions, sections, or parts thereof are determined on the detector by the evaluation of two radiographic images in each case, preferably by the determination of the centre of gravity of the calibration object or the regions, section, or parts in the respective radiographic image,
the known position change of the calibration object or of the regions, sections, or parts, taking account of the image scale, defined by the ratio of the “distance interval from detector to radiation source” to the “distance interval between measured object or, respectively, calibration object to radiation source” of the computed tomography sensor system, is converted into a reference displacement of the calibration object or the regions, sections, or parts, on the detector,
the deviations between reference and actual displacement (reference-actual deviations) are determined, and
the pixel ranges of the detector acquiring the calibration object or the regions, sections, or parts, in the different positions, corresponding to the reference-actual deviation, are displaced relative to each other for the formation of a corrected radiographic image.

4. Method according to claim 1, characterized in that the relative displacements take place in relation to the middle region of the detector, wherein at least one radiographic image is taken in which the calibration object or, respectively, the region, section, or part of the calibration object is imaged approximately in the middle on the detector.

5. Method according to claim 1, characterized in that, as radiographic image, a radiographic image is used which is composed of part radiographic images, wherein the part radiographic images are taken by a plurality of extended surface part detectors, which are arranged directly next to one another in the detector plane, wherein preferably 2×2 part detectors are used, and, preferably, the correction takes place separately for each part radiographic image, in that, per part detector, radiographic images are taken in different relative positions to the part detector for a calibration object or for one or more regions, sections, or parts thereof.

6. Method according to claim 1, characterized in that, the correction values for all detector pixels are determined by means of interpolation from correction values of adjacent regions or pixels of the detector.

7. Method according to claim 1, characterized in that the interpolation of correction values takes place in each case only for the detector pixels inside a part radiographic image.

8. Method according to claim 1, characterized in that the corrected radiographic images are provided by means of resampling in the original grid.

9. Method according to claim 1, characterized in that the corrected radiographic images are used for the reconstruction of the volume data.

10. Method according to claim 1, characterized in that the correction of the imaging errors is used in a new and more precise calibration of the image scale or, respectively, the magnification, i.e. the determination of the geometry of the computed tomography sensor system, and in the measurement of the geometry of an object such as a workpiece or component.

11. Method according to claim 1, characterized in that the measurement of the different radiographic images of the calibration object or of one or more regions, sections, or parts thereof, for the determination of the imaging errors and the determination of the image scale or, respectively, the magnification of the computed tomography sensor system, are carried out in one common method step and with the same calibration object or, respectively, the regions, sections, or parts, wherein, preferably, first the magnification is determined and then the imaging errors, and these two steps are repeated one or more times in an iterative manner.

12. Method according to claim 1, characterized in that the calibration object comprises an arrangement of a plurality of preferably spherical elements, and is arranged in such a way that the plurality of elements extend parallel to the axis of the mechanical axis of rotation, and the different relative positions are adopted with the same distance interval to the detector.

13. Method according to claim 1, characterized in that the calibration object, or the region, section, or part thereof, is arranged off-centre to the axis of the mechanical axis of rotation, wherein, preferably, the distance from or, respectively, the location of the axis is known, the calibration object, the region, section, or part thereof preferably consists of a plurality of spheres, arranged offset in the direction of the axis of the mechanical axis of rotation, and the different relative positions are adopted by the different rotational positions of the mechanical axis of rotation, and the imaging errors are determined by taking account of the image scale present, dependent on the respective rotational position.

14. Method according to claim 1, characterized in that the calibration object is connected to a clamping device of the object, such as the workpiece or component, or to the mechanical axis of rotation.

15. Method according to claim 1, characterized in that, as calibration object, a sphere is used, or an arrangement of a plurality of spheres, or the object to be measured, or a region or section thereof.

16. Coordinate measuring machine for carrying out the method according to claim 1, comprising a computed tomography sensor system with a radiation source (1), an extended flat detector (2), and, as appropriate, a mechanical axis of rotation (19) penetrated by an axis (20) for accommodating the object, characterized in that a calibration object (4) is connected by a clamping device connected to the axis of rotation for the object or to the mechanical axis of rotation, and that the connection, or a holding element allowing for the connection, consists of a material which has a lower absorption than the calibration object, in relation to the measurement radiation being emitted from the radiation source.

17. Coordinate measuring machine according to claim 16, characterized in that the calibration object (4) comprises one or more elements, in particular a sphere or an arrangement of a plurality of spheres (4a, 4b, 4c), which in each case, by means of at least one securing element (25), are located at a distance from one another or from a basic body, and that the calibration object can preferably also be used as a drift body and/or for the determination of the image scale of the computed tomography sensor system.

18. Coordinate measuring machine according to claim 16, characterized in that the plurality of elements of the calibration object (4) extend along the axis (20) of the mechanical axis of rotation (19) or are arranged off-centre to the axis of the mechanical axis of rotation, wherein preferably the offset calibration object is arranged in such a way that, on rotation of the mechanical axis, it can only be shadowed by the securing element of lesser absorption, i.e. it is located above a rotation plate of the mechanical axis of rotation, wherein preferably the absorption of the element is at least five times less than that of the calibration object.

19. Coordinate measuring machine according to claim 16, characterized in that the one or more elements such as spheres (4a, 4b, 4c) are secured in a holder, preferably a cylindrical holder (25), which comprises one or more openings (26) running transversely to the cylinder axis, in which, in each case, one or more elements such as spheres are arranged on connection elements secured in the cylinder, such as webs or pins, or in another material, for example of foam type, which has a lower absorption than the element(s).

20. Coordinate measuring machine according to claim 16, characterized in that the plurality of spheres (4a, 4b, 4c) are arranged offset to one another in the direction of the axis (20) of the mechanical axis of rotation (19).

21. Coordinate measuring machine according to claim 16, characterized in that the extended flat surface detector (2) consists of a plurality of extended flat surface part detectors, which are arranged in the detector plane directly next to one another, and the radiographic images assembled for the production can be used, wherein preferably the part detectors (2-1, 2-2, 2-3 and 2-4) are arranged in a 2×2 grid.
